(19) United States
(12) Patent Application Publication
(10) Pub. No.: US 2014/0052421 A1
(43) Pub. Date: Feb. 20, 2014

(54) SYSTEM AND METHOD FOR WATER DISTRIBUTION MODELLING

(71) Applicants: Michael Allen, Singapore (SG); Daniel Goldsmith, Coventry (GB); Amitsur Preis, Singapore (SG)

(72) Inventors: Michael Allen, Singapore (SG); Daniel Goldsmith, Coventry (GB); Amitsur Preis, Singapore (SG)

(73) Assignee: Massachusetts Institute of Technology, Cambridge, MA (US)

(21) Appl. No.: 13/823,029

(22) PCT Filed: Sep. 13, 2011
(86) PCT No.: PCT/SG11/00310

§ 371 Date: Nov. 4, 2013

Related U.S. Application Data
(60) Provisional application No. 61/382,489, filed on Sep. 14, 2010.
(60) Provisional application No. 61/382,491, filed on Sep. 14, 2010.

(51) Int. Cl. G06F 17/50

(52) U.S. Cl. CPC G06F 17/5009
USPC 703/2; 703/9

(57) ABSTRACT

A method of modelling a water distribution system, the method comprising steps of: identifying a plurality of demand zones within said water distribution network; estimating water consumption data for said demand zones; simulating the hydraulic characteristics of the water distribution system using said estimated water consumption data and so; providing simulated pressure and flow rates within said demand zones; receiving output from sensors within said water distribution network in the form of pressure and flow rate data; correcting the simulated pressure and flow rate data within said demand zones based upon the sensor output and so; calibrating a model of the water distribution system.

### FIELD OF THE INVENTION

The invention relates to the modelling of water distribution systems for the operation thereof and prediction of water consumption within said system.

### BACKGROUND

In establishing a water distribution network within an urban environment, the associated changes to the environment will inevitably affect water demand within the network. Given the complexity of the system, for engineers to predict the consequences of change it is necessary to undertake mathematical models of the network, and use these to predict outcomes and re-design the system for better management of this demand.

To this end, once the model is created it is necessary to calibrate it against known data to ensure such predictions are reliable.

A limitation of such calibration procedures is that they approximate the unknown parameters using a short-term sample of hydraulic data. The calibration results may represent the system hydraulics during the short period of the sampling procedure but are not expected to represent accurately the system conditions for the full range of operational conditions that can occur.

Consequently, any such model will suffer from an inadequate calibration, throwing into question the results following a significant change to the system.

Further, even following a series of minor modifications to the system, the model will incrementally depart from that of the original model. Thus, even if the calibration is representative of the medium or long term performance of the system, changes to the system will introduce further errors into the model. Accordingly, as time passes the value of the model diminishes.

To highlight this effect, it will be appreciated that such changes need not be restricted to infrastructure change, but also to deterioration of the network and even changes in demand following re-zoning, industrial development and demographic change.

The resources, both in terms of time and money, which are required to generate such models may make their periodic re-establishment, in order to maintain validity, uneconomic.

### SUMMARY OF INVENTION

In a first aspect the invention provides a method of modelling a water distribution system, the method comprising steps of: identifying a plurality of demand zones within said water distribution network; estimating water consumption data for said demand zones; simulating the hydraulic characteristics of the water distribution system using said estimated water consumption data and so; providing simulated pressure and flow rates within said demand zones; receiving output from sensors within said water distribution network in the form of pressure and flow rate data; correcting the simulated pressure and flow rate data within said demand zones based upon the sensor output and so; calibrating a model of the water distribution system.

In a second aspect the invention provides a method of determining the output from a virtual sensor, the method comprising steps of providing historical output from a temporary sensor comparing historical output with output from at least one permanent sensor determining a correlation between said temporary sensor and permanent sensor output then receiving subsequent output from said at least one permanent sensor and determining a virtual sensor output of a virtual sensor corresponding to the temporary sensor using subsequent output and correlation.

Accordingly, the invention provides an improved hydraulic modelling system and method for a water distribution system.

The integration of a continual steam of hydraulic data with computer simulations may be used for on-line operation and control of large-scale urban water distribution systems, and may be used in a variety of applications ranging from real-time optimization of pump and valve settings for efficient power and pressure management; to the detection and quantification of leaks. Such a system may also be used for the implementation of water security systems and for the prediction of system performance during emergency events (e.g., pollution events, main pipe rupture, or significant fire).

In one embodiment, the invention may implement a Predictor-Corrector (PC) approach to integrate continual sensor output. Such output may provided by a wireless sensor network, Supervisory Control & Data Acquisition (SCADA) system, and/or from external information such as climatic conditions and day classification (weekday, weekend, public holiday) to update predictions of the hydraulic states of urban water supply networks at regular time intervals. Such SCADA data may include elevation data from reservoirs, outflows from pumps and other transmission data.

### BRIEF DESCRIPTION OF DRAWINGS

It will be convenient to further describe the present invention with respect to the accompanying drawings that illustrate possible arrangements of the invention. Other arrangements of the invention are possible, and consequently the particularity of the accompanying drawings is not to be understood as superseding the generality of the preceding description of the invention.

FIG. 1A is a schematic view of a water distribution system;

FIG. 1B is a graph of measured pressure variation;

FIG. 2 is a flow diagram of a method according to one embodiment of the present invention;

FIG. 3 is a schematic of a demand zone arrangement according to a further embodiment of the present invention;

FIGS. 4A and 4B are graphs of predicted water usage using a method according to one embodiment of the present invention;

FIG. 4C is a graph showing convergence of the calibration model according to a further embodiment of the present invention;

FIGS. 5A to 5D are graphs of comparison data between predicted and observed output from various sensors using a method according to a further embodiment of the present invention;

FIG. 6 is a schematic view of a method incorporating a virtual sensor according to one embodiment of the present invention;

FIGS. 7A and 7B are graphs showing comparative data between actual and virtual sensors;

FIGS. 8A to 8C are graphs showing comparative data between actual and virtual sensors, and;

FIGS. 9A and 9B are graphs showing comparative data between actual and virtual sensors.

### DETAILED DESCRIPTION

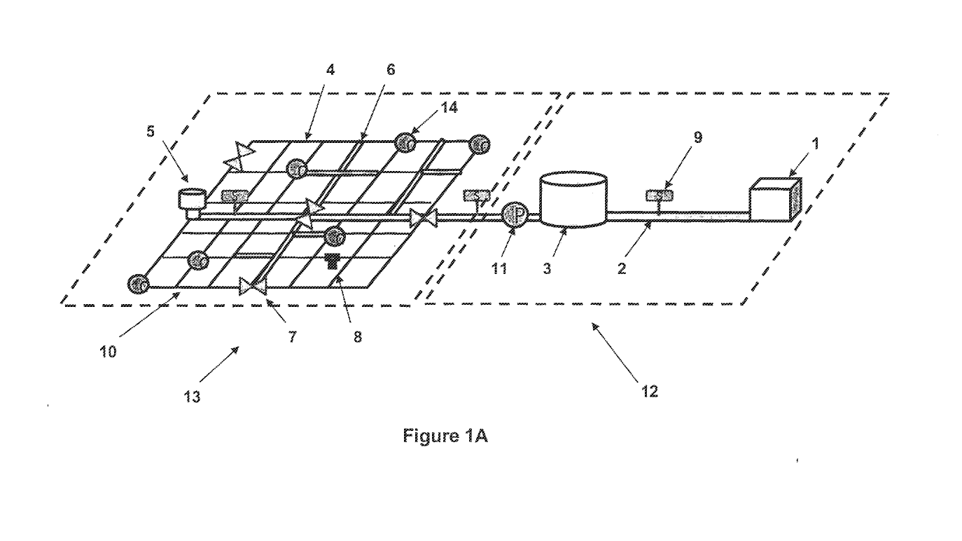

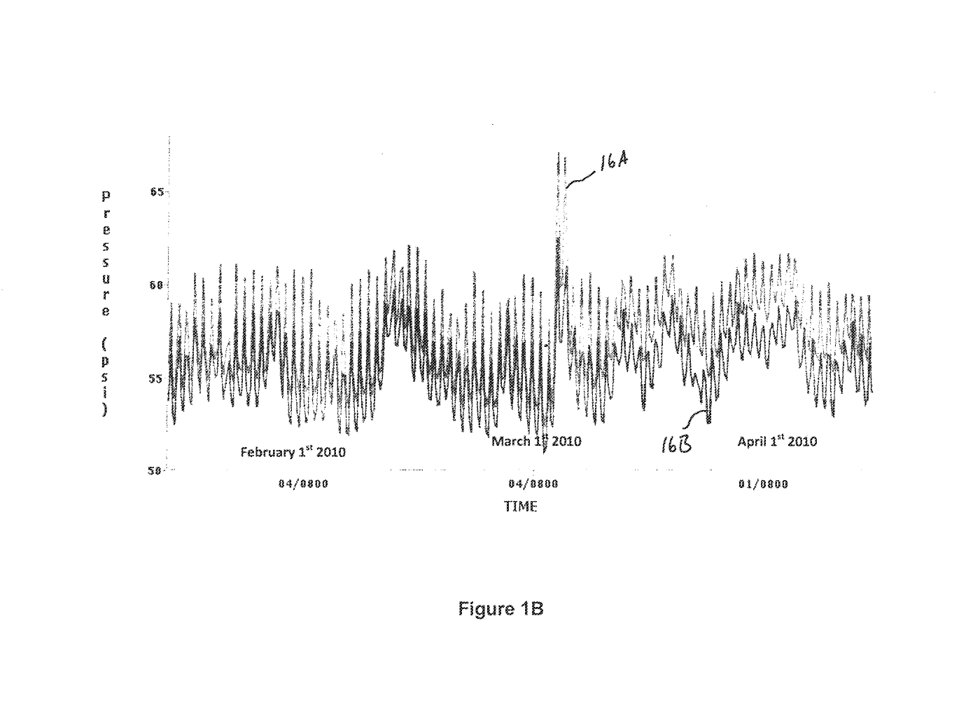

The invention relates to the hydraulic modelling of a water distribution, such as that shown in FIG. 1A. It will be appreciated that infrastructure associated with a water distribution system will be divided into a transmission system 12 and a distribution system 13.

The transmission system 12 may include treatment plants 1 and reservoirs 3 connected by large diameter transmission pipes 2, with the flow of water primarily driven by pumps 11.

The distribution system 13 acts to deliver water to the various end customers 14 through a branched arrangement having a range of different infrastructure including water storage towers 5, distribution mains 4, branched network sections 6 and domestic/commercial feeder mains 10, with customers demonstrating a demand based upon a desired water consumption. In addition, within each of these sections will be various control points including selectively controllable valves 7, and fire hydrants 8.

Further, instrumentation, including pressure and flow rate sensors 9, is placed throughout the system. Output from said sensors 9 may be communicated back to a central control, readable directly on site, accessed remotely in the field or any combination of these alternatives.

Collectively, the water consumption demand of these end customers may be represented by demand zones based upon similar demand characteristics, geographical “sub-systems” or other criteria permitting planners and operational staff to be able to simplify the complexity of individual consumer demand and adequately manage a broad based water distribution system. It is based upon this broad systemic arrangement, that the present invention is applied in order to satisfy the operational needs and predicted future growth of such a system.

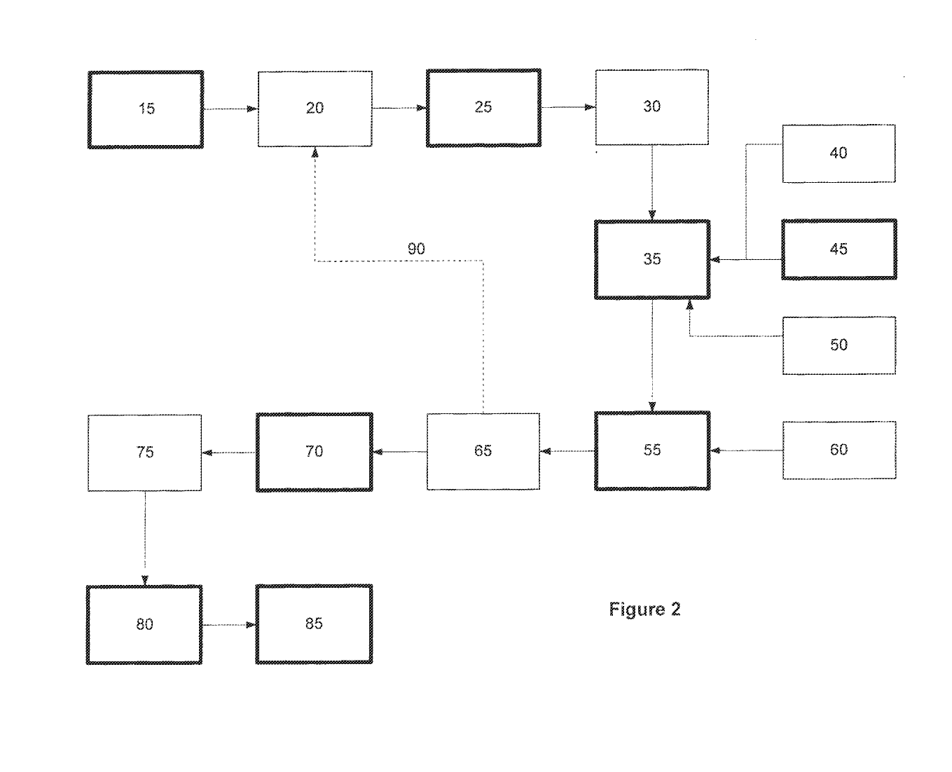

FIG. 2 shows a flow chart representing the hydraulic modelling process for a water distribution system according to one embodiment of the present invention.

As shown in FIG. 2 above, the proposed method starts with identifying demand zones 15 (i.e., homogeneous clusters of water consumers) within the complex topology of the urban water supply system.

Next, total water consumption for each demand zone (at time t) is estimated 20, followed by the system hydraulics being simulated 25 using the steady-state mode of a hydraulic network solver/simulator with the estimated demand zone water consumptions 20 as inputs; the hydraulic simulation outputs are nodal pressures and pipe flow rates 30.

Simulated pressure and flow data 30 measured pressure and flow data from a set of in-line sensors 40 SCADA data 50 on the water network reservoirs' and pumps' operational states and virtual sensors data 45 that predict missing or faulty sensor data are integrated simultaneously into the model at time step t.

A calibration problem is formulated and solved using an evolutionary optimization approach 35. Whilst different optimization strategies may be used, in this case, the objective function is the minimization of the differences between predicted and measured hydraulic parameters (i.e., pressure and flow rates at the measured locations), with the decision variables being the demand zones' water consumptions. A modified Least Squares fit method which takes into account noisy measurements is implemented to solve the optimization problem.

Next, a statistical data-driven algorithm 55 is applied to predict future water demands 65 of each zone for time: t+24 (hrs). The input data for this process include corrected outputs of the Calibrator/corrector process 35, external information 60 on the expected climatic conditions at time: t+24 (hrs) and the upcoming day classification (weekday, weekend or public holiday).

This process starts at time: t+24 (hrs) and that continues at each subsequent time step, the predictor-corrector loop 90 is implemented. In this process the demand zones' water consumption predictions are used as inputs to the simulator 70. This a-priori estimation of the calibrator parameters values repeats itself 90 at each subsequent time-step while the forecasting model inputs correspond to the corrected outputs of previous iterations, thus improving the model performances over time.

The hydraulic states of the water network for future time steps (predicted pressure and flow rates for time: t+24 (hrs) 75) are calculated 80 to provide adequate information, which is subsequently verified 85 for real-time decision support of operation and control of the water system at t+24 hrs.

Integration of data from continually streamed sensor output with hydraulic computer simulation models allows water utility engineers to operate and control their large-scale urban water distribution systems in real time, and presents an improvement over the conventional practice at which hydraulic models are calibrated off-line using a short-term (e.g., one week) sample of flow rate and pressure measurements within the network. In these procedures, uncertain system parameters (e.g., water demands and/or pipe roughness) are adjusted using optimization techniques until an acceptable match is achieved between the model outputs and physical observations.

There are thousands of water consumers with highly variable and stochastic individual demand behavior to be estimated in a typical urban water system and only a relatively small number of direct measurements are available. This creates an ill-posed, highly under-determined calibration problem which results in non-unique solutions. This can be addressed by grouping the unknown parameters. The main advantage of ‘grouping’ is that the size of the problem is reduced. By reducing the problem uncertainty, it is more feasible to predict aggregated demands than individual ones.

The consumption nodes may be grouped as demand zones based upon three criteria to identify clusters in the water system such that (1) the within-cluster homogeneity of water consumers' characteristics is maximized; (2) the overall variance between total water consumption of the system's clusters is minimized; and (3) the number of connecting links between neighboring clusters is minimized.

The predictor-corrector approach 35, 55 of FIG. 2 is implemented to integrate near real-time hydraulic data 40, 45, and 50 with a hydraulic computer simulation model 35. The proposed method employs a Predictor-Corrector (PC) procedure for forecasting future water demands in the water system demand zones.

It will be appreciated that such a system may also be implemented as an on-line system, with data access through wireless sensors so as to provide field engineers access to the near real-time data and modelling.

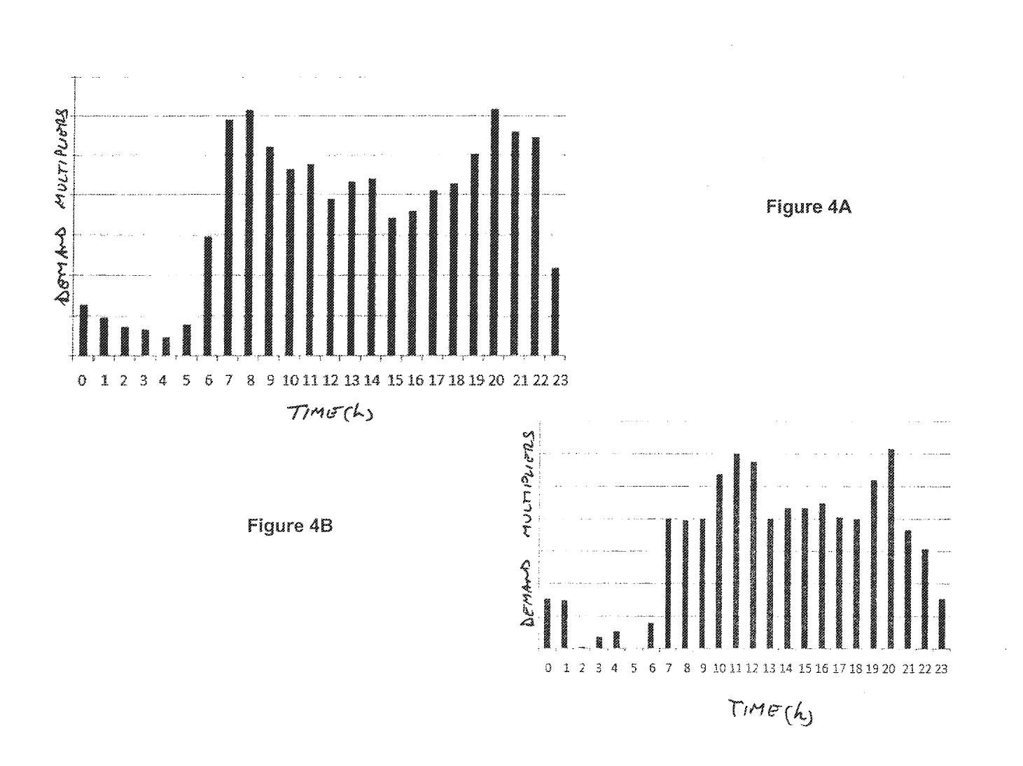

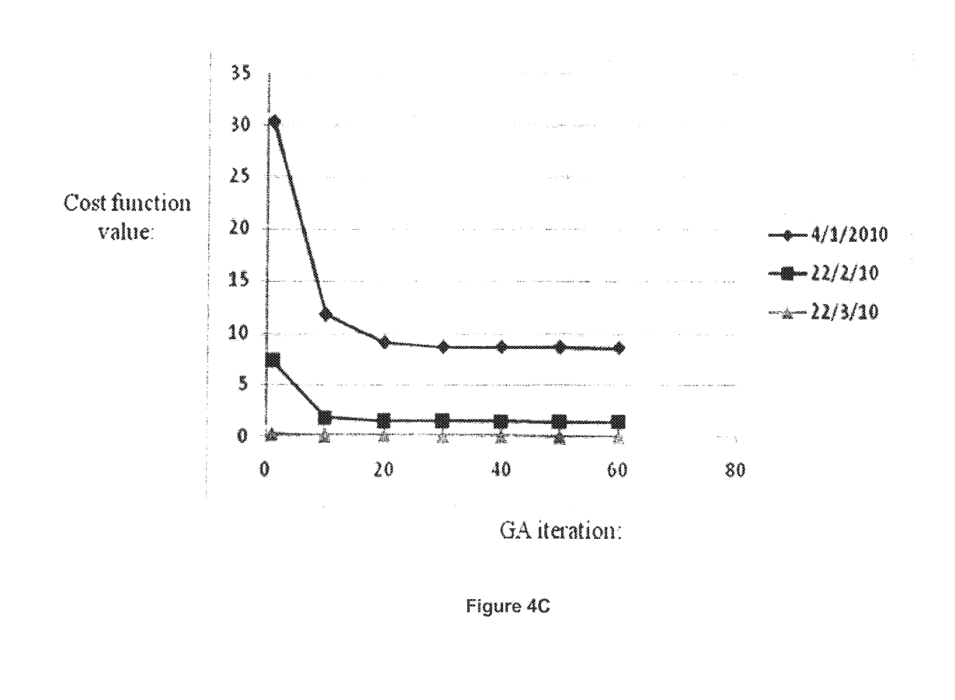

The patterns in demand for hourly-basis time-steps are described by Demand Multiplication Factors (DMFs). In any time step, the water consumption at a given location can be found by multiplying the relevant DMF by the baseline demand. Consumption nodes may be grouped into demand zones based on a clustering process and each group of consumption nodes is assigned its own set of DMFs. Thereafter, the demand zones DMFs are predicted using a statistical data driven method, with the inputs being the calibrated DMFs from past hours t-24, t-25, t-168, and t-169. For instance, as shown in FIGS. 4A and 4B, where DMFs have been selected for 23 separate demand zones. These time cycles (i.e., weekdays diurnal demand pattern which follows a 24-h cycle and weekends pattern which follows a 168-h (1 week) cycle) are based on a time-series forecasting of water demands which relies on direct identification of patterns existing in the archived system data.

The system hydraulic behavior may be simulated using one of a range of differed processes. For instance, the steady-state mode of EPAnet with updated boundary conditions of the system, and with the predicted DMFs as inputs, with the simulation outputs being nodal pressures and pipe flow rates.

The objective of the calibration process is to match the computed and measured sensor node data (pressure and/or flow rates), taking into consideration possible noise in the measurements. In this application, calibration is achieved by solving an optimization problem at which a modified least-squares of differences function known as the Huber function which accounts for noisy measurements is minimized using Genetic Algorithm. The Huber function implementation to the hydraulic state estimation problem is described by the following computation steps:

The differences (i.e., residuals) between modeled and observed pressures and flow rates at each time step, at sensor node i—are defined as RPi,t=k and RQi,t=k respectively The Huber function of each residual R is defined as

$$f ( {R}_{i , t}^{P or Q} ) = \{ \begin{matrix}\frac{1}{2} {( {R}_{i , t}^{P or Q} )}^{2} , & \vert {R}_{i , t}^{P or Q} \vert \leq h \\ h \vert {R}_{i , t}^{P or Q} \vert - \frac{1}{2} {h}^{2} , & \vert {R}_{i , t}^{P or Q} \vert > h\end{matrix} \qquad ( 1 )$$

where h is a predefined value that represent the tolerance to noise in measurements; for small residuals (|R|≦h) that represent low to zero values of noise in sensor measurements, the Huber function minimizes the usual least squares function (i.e., l2 norm approximation), for large R (|R|>h) that represent high values of noise in sensor measurements, it minimizes a linear penalty function which is relatively insensitive to noise (i.e., l1 norm approximation)

The overall calibration problem objective function to be minimized at each hydraulic time-step t is defined as

Σᵢ₌₁^{N}^{_{P}}f(R_{i,t}^{P})+Σᵢ₌₁^{N}^{_{Q}}f(R_{i,t}^{Q}) (2)

where i is the sensor nodes index, Np is the total number of pressure sensors, and NQ is the total number of flow rate sensors. In this application, the value of h in each sensor node at each time-step is equal to the average of all previous time-steps sensor node residuals multiplied by a factor of 2.

The calibrated DMFs are delayed for 24, 25, 168, and 169 hrs before being used as inputs in the prediction model.

Steps 25 to 70 as shown in FIG. 2 start at t=169 hr, after performing an off-line calibration procedure for the first 168 hrs (1 week) of the collected data; the aim of this off-line calculation is to generate initial values for the input data-set of the prediction model. No a-priori information is used during the first 168 hrs apart from constraints on the minimum and maximum values of DMF (0.0-3.5, respectively).

FIG. 1B illustrates the dynamic behavior of the monitored water system which is reflected in the variations in pressure measurements 16A, 16B over a period of three months at two sensor nodes installed on a pipeline system. As it can be observed the pressure trend is unsteady due to the dynamic/stochastic water consumption pattern variations and changes in the system operation. An offline calibrated hydraulic model of this water system using a short-term sample of hydraulic data will not represent the system's hydraulic behavior in the long run after the short period of the sampling procedure.

The sensor nodes may be designed to continually gather data and transmit in real-time to a central data server. The sensor node may support the attachment of two different sensors which may be useful for the hydraulic modeling process: a pressure sensor and a flow meter. Each of the installed nodes may be connected to a water main through a standard tapping point that can enable multiple sensor measurements at a single point in the water distribution network.

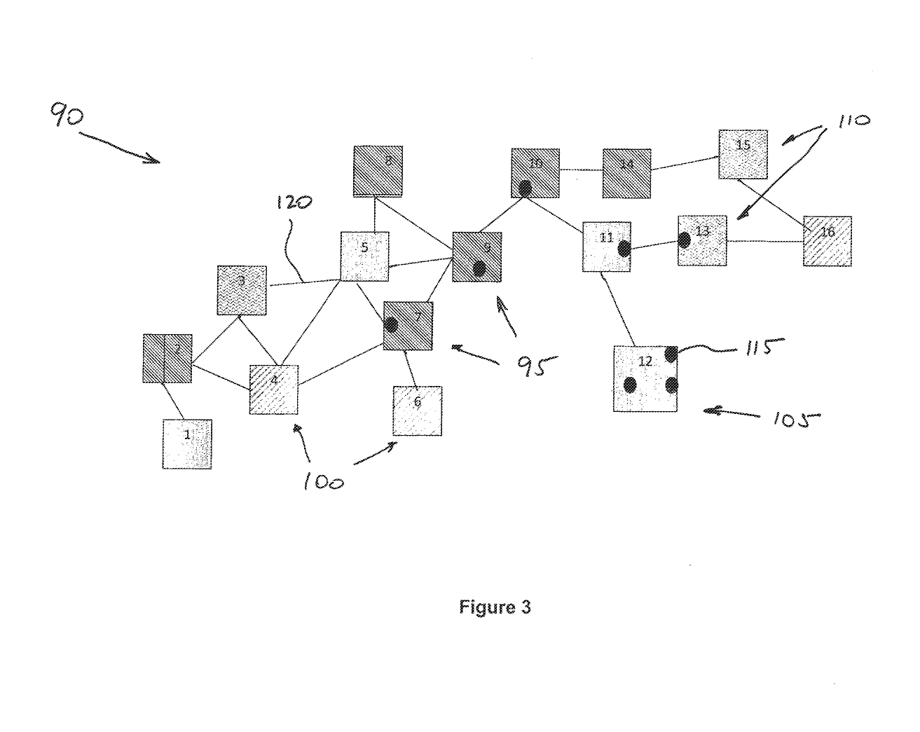

FIG. 3 shows the arrangement 90 of demand zones in a block diagram. The current deployment of the sensor nodes 115 within the demand zones are also given in FIG. 3.

The sensor node locations may be based on an optimized sensor network layout for monitoring both the system hydraulics and water quality. Alternatively, the sensor nodes may be historically placed for other purposes, with the hydraulic modelling using available sensors, as well as new sensors placed to supplant an existing array.

Boundary conditions of the system (i.e., reservoirs' water levels and outflows) may be provided by the water utility SCADA system in near real-time manner and may also be assimilated in the hydraulic model. In case a sensor node data streams is temporarily interrupted a data imputation technique may be implemented where data trends in each node's data stream are tracked and data is predicted (when real stream is unavailable) using a technique based on Gaussian Process Regression

The method according to the present invention may include a wide range of hydraulic modeling time-step intervals so that even frequent continuous sensor measurements, can be used in the model. In the current embodiment reporting hydraulic states has been fixed to a one hour time step and therefore the hydraulic measurements are averaged for each round hour respectively. An alternative approach may be to shorten the time-steps to 15 min intervals. It will be appreciated that any regular time-step is permissible within the scope of the invention. The actual time-step used may depend upon a range of factors including the data acquisition system used, the expected rate of change of parameters and/or conditions etc.

In order to gain confidence in the model, several measures may be used to evaluate its performance: (1) the predicted diurnal demand patterns of two homogeneous demand zones (residential and commercial) were compared to typical diurnal curves for residential and commercial water usage (2) the convergence of the genetic algorithm objective function during the calibration/correction process which is a component of the online predictor-corrector model was analyzed at three different occasions (1, 8, and 12 weeks after the initialization of the on-line hydraulic model) to check if the model performances improve through experience; and (3) the model predictions for the system's hydraulic state were cross-validated with supplementary independent pressure and flow-rate measurements over a period ranging from 24 to 48 hours in four different locations across the water distribution system.

A diurnal pattern for a residential area is characterized by relatively low usage at night when most people sleep, increased usage during the early morning hours as people wake up and prepare for the day, decreased usage during the middle of the day, and finally, increased usage again in the early evening as people return home. For commercial demand zones, the typical usage pattern is different. A broad classification, such as commercial zone, may contain many types of consumers such as shops, restaurants, hotels, and offices therefore we expect to see increased consumption during the entire working day with peak usage during lunch hours and evening when more people are around these areas. As can be observed in FIGS. 4A and 4B (predicted diurnal water usage pattern in residential and commercial zones respectively) the predicted demand patterns for these homogeneous clusters are in agreement with the expected water usage as described above where in the residential zone we see morning and evening peaks in demand and in the commercial zone we see relatively constant water usage during office hours with increased consumption around lunch time and evening.

The calibration component in the Predictor-Corrector model minimizes the modified least-squares of the differences (Eq. 2) between predicted and measured hydraulic parameters (i.e., pressure and flow rates at several system locations), with the decision variables being the consumers' water demands. The initial values for the decision variables are the predicted demands at the previous time steps. Since the Predictor-Corrector loop repeats itself at each subsequent time-step with the forecasting model inputs being the corrected outputs of previous iterations, it is expected that the model performance improves over time. FIG. 4C illustrates the Calibration problem objective function convergence through the GA iterations at three different occasions: 1, 8, and 12 weeks after the initialization of the on-line system model. It can be observed that the a-priori estimation (i.e., prediction) of the values of the decision variables, which improve through experience, facilitates a better convergence of the calibration model and provides adequate information on the system's hydraulic state for real time optimization.

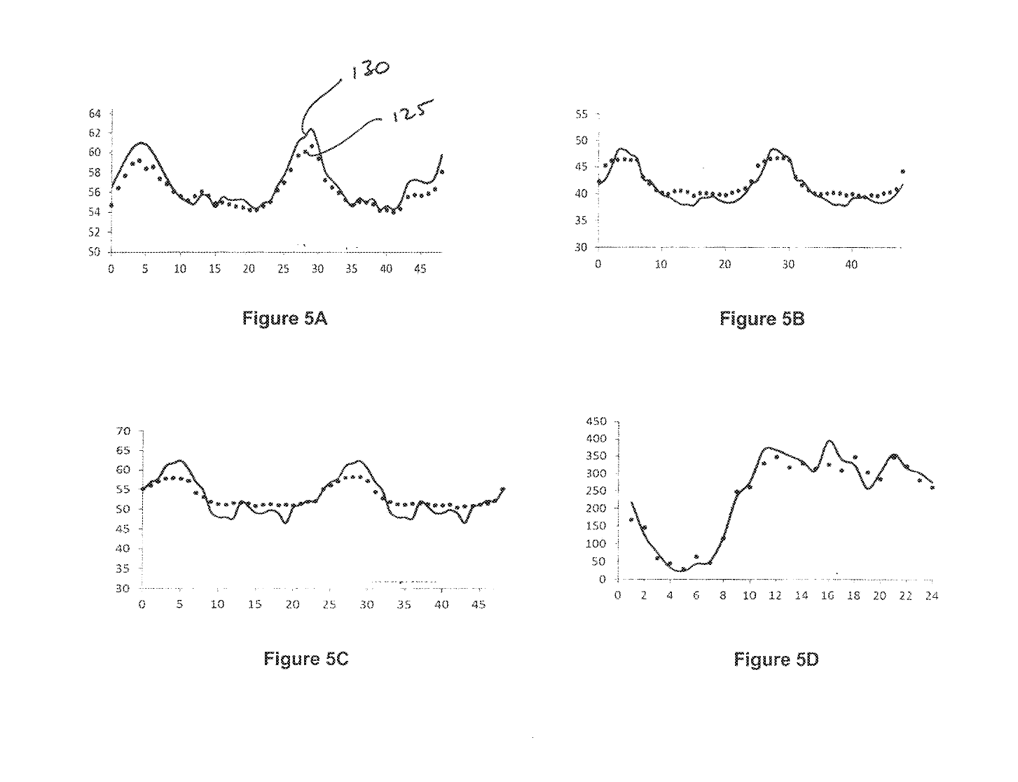

FIGS. 5A to 5C show a comparison between the field observed 125 and model predicted 130 pressure for a 48 hrs duration of the supplementary pressure sensor deployment. The results for supplementary pressure sensor 1 (FIG. 5A) which is located in zone 12 show a mean absolute error of 0.85 psi for all 48 data points, and a maximum absolute pressure difference of 2.4 psi. For supplementary pressure sensor 2 (FIG. 5B) which is located in zone 3 the mean absolute error is 1.22 psi for all 48 data points, and the maximum absolute pressure difference is 2.6 psi. For supplementary pressure sensor 3 (FIG. 5C) which is located in zone 1 the mean absolute error is 1.9 psi for all 48 data points, and the maximum absolute pressure difference is 4.6 psi.

FIG. 5D shows a comparison between field observed and model predicted flow rates for the 24 hrs duration of the supplementary flow meter deployment on an 800 mm main connecting zones 11 and 13. The results for this cross validation measurement show a mean absolute error of 23 m3/hr for all 24 data points, and the maximum absolute flow rate difference is 65 m3/hr.

An alternative arrangement to the use of real sensors is for the use of “virtual sensors” By way of example, wireless sensor nodes may be permanently deployed within a distribution system, providing continual hydraulic data that can be assimilated into hydraulic models.

Further temporary nodes may be deployed for short periods (say, one week) around the distribution system/network.

A Virtual Sensor is implemented using a data imputation technique called Gaussian Process Regression, which combines the historical data collected by the temporary node with correlated data from a subset of permanent sensor nodes. Use of spatially-correlated data accounts for new trends in the data that do not appear in the historical data collected by the temporary node. An increase in the number of sensors (a combination of real and virtual) is important for reducing the ill-conditioned state of the hydraulic model calibration procedure.

It will be appreciated that the use of virtual sensors, according to one aspect of the invention, in applications other than the hydraulic modelling application is possible. For instance, the use of instrumentation within complex or diverse petro-chemical applications can be expensive. By conducting a survey of a plant having an array of permanent sensors, establishing temporary sensors at useful locations for a time sufficient to establish a clear correlation with the permanent sensors may lead to significant economic benefits, in terms of the number of sensors required and the infrastructure to monitor such sensors. Further, whilst water pressure and flow rate are parameters selected for measurement by the virtual sensors related to the WDS, other applications may require different parameters measured. Hence, the concept of the virtual sensor may be adapted to provide output in measured quantities according to the application, for instance, 3-phase current for an electrical distribution system, gas pressure for a natural gas distribution system, and even cars/hour for a traffic management system, assuming reliable correlations can be established.

To further investigate the scope of the invention as it relates to virtual sensors, embodiments relating to the hydraulic modelling application will be used. This shall not be seen as limiting on the application of virtual sensors according to the present invention.

In Water Distribution Systems (WDS) analysis, models can be used to estimate dynamically the hydraulic state of the system. Understanding the dynamic state of the water distribution system can help WDS engineers schedule and simulate operational changes based on up to date knowledge of the system.

On-line hydraulic models attempt to solve an estimation and calibration optimization problem where a limited number of inputs are being used to calibrate a system comprised of thousands of unknowns. The data inputs provided to on-line hydraulic models are typically a small number of field measurements of hydraulic parameters (e.g. pressure and/or flow rate) taken at various sites across the network. Because the hydraulic modelling is intended to run in an on-line manner, the input data may ideally be provided from all sites at consistent time steps (e.g. at hourly intervals).

The solution procedure for the estimation and calibration optimization problem is ill-posed and under-determined. It may be significantly improved by adding more sensors across the area covered by the network to provide more data inputs. However, making physical measurements within the system is expensive and requires time and effort in deployment and maintenance of transducers and data acquisition units.

The addition of virtual sensors, whose data stream is predicted on-line using the data of physically deployed sensors may provide significant benefit in solving this issue. At some points in the network, data may well correlate with other sites. This correlation may be exploited to use the data being gathered at an existing sensor to predict the data at the virtual sensor. A non-parametric, machine learning technique called Gaussian Process Regression (GPR) may be used to impute data based on time history and spatial correlations between sensors. Section 2 gives an overview to the technique, showing how candidate virtual sensors are determined.

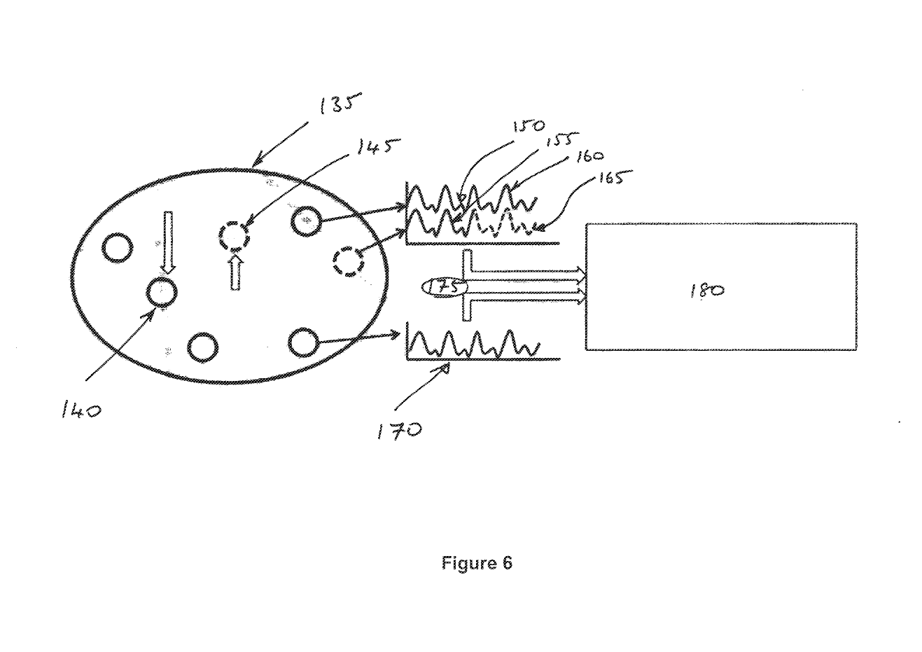

FIG. 6 shows an overview of the Virtual Sensors concept as deployed to monitor a WDS. A set of pressure transducers 140 are deployed within the WDS 135, and their real-time data 150 are used as input to the on-line hydraulic model. The solid circles 140 represent real sensors that are permanently deployed on the WDS. The dashed circles 145 represent Virtual Sensors, whose data is predicted based on a small window of training data and the current data gathered by a real sensor has been observed to be well-correlated with that training data.

The process of integrating a Virtual Sensor into the system has two steps, site selection and data prediction. Site selection is necessary to determine whether a given physical site will be a suitable candidate for a Virtual Sensor. To determine whether a site is suitable, a week's worth of pressure data must be gathered at the candidate site. Hourly averages of this data are taken and compared to a corresponding time period from other sensors in the system. If the week's worth of hourly averages correlate well with any sensor (r >0.99 for instance), the site is suitable to be a Virtual Sensor. Sites where the data are poorly correlated with other sites in the network represent ideal places for the placement of new, static sensors. Once a site has been validated as suitable, the week's worth of data, and the continuing stream from the correlated sensor are used to predict the data stream from where the sensor would have been deployed.

Regression analysis is generally used to help understand the structure of a data set, allowing a function y=f (x) to be derived for the underlying data, describing the relationship between the input variable x and output variable y. For instance, a common function in linear regression y=mx+c describes a straight line through the data, with slope m and intercept c. Using this function it is possible to interpolate (regression) or extrapolate (prediction) possible values at times where no sample is available. However, with complex data it can be difficult to determine the underlying model.

Machine learning algorithms such as neural networks have historically been used for such multivariate regression problems. In an attempt to address practical difficulties and simplify design decisions (such as choice of learning rate) associated with supervised neural networks, Bayesian techniques such as Gaussian Process Regression (GPR) have been proposed. GPR has been widely used in the geo-statistics domain but is only recently being applied to other fields, such as sensor networks. GPR uses Gaussian Processes (GPs) to provide a probabilistic framework for regression. The observations in a given data set can be seen as a sample from some multivariate Gaussian distribution. The relationship between these observations is defined by the covariance function k(x,x′), representing the correlation between samples.

The regression process begins by encoding the relationship between observations using the covariance function k(x,x′) for all combinations of inputs x into the covariance matrix K

$$K = ( \begin{matrix}k ( {x}_{1} , {x}_{1} ) & k ( {x}_{1} , {x}_{2} ) & … & k ( {x}_{1} , {x}_{n} ) \\ k ( {x}_{2} , {x}_{1} ) & k ( {x}_{2} , {x}_{2} ) & … & k ( {x}_{2} , {x}_{n} ) \\ ⋮ & ⋮ & ⋱ & ⋮ \\ k ( {x}_{n} , {x}_{1} ) & k ( {x}_{n} , {x}_{2} ) & … & k ( {x}_{n} , {x}_{n} )\end{matrix} ) \qquad ( 1 )$$

At each regression step, the covariance between training data and the point of interest x* (the point to be predicted) is calculated, giving rise to two covariance matrices representing the relationship between observed data and the point of interest:

K_{*}=[k(x_{*},x₁)k(x_{*},x₂) . . . k(x_{*},xₙ)] (2)

K_{**}=k(x_{*},x_{*}) (3)

Using the above notation, the input data is defined as a sample from a Gaussian distribution as follows

$$[ \begin{matrix}y \\ y *\end{matrix} ] \sim 𝒩 ( 0 , [ \begin{matrix}K & {K}_{*}^{T} \\ {K}_{*} & {K}_{**}\end{matrix} ] ) \qquad ( 4 )$$

For prediction, the aim is to determine conditional probability of test values y* given the observed data y. This itself is a Gaussian with probability

P(y_{*}|y)˜ [symbol] (K_{*}K⁻¹y,K_{**}−K_{*}K⁻¹K_{*}^{T}) (5)

From this the value at x* can be inferred by taking the mean of this distribution.

x̅_̅{̅*̅}̅=K_{*}K⁻¹y (6)

Rather than directly invert the matrix as in the above equations, a practical implementation of Gaussian process regression will make use of a computationally faster approach, such as Cholesky decomposition.

A key part of using GPR to generate test outputs y (the predictions) is the design of the covariance function k(x,x′) used to create K. The reliability of the regression is dependent on a well-specified covariance that allows the complexities of the input data set to be captured. The Virtual Sensors approach implies that predictions incorporate both the historical data trace of data gathered at the candidate site and the current data from the well-matched real sensor. Both of these data sources can be included in the covariance function, as described in the rest of this section.

The output of the regression (i.e. predictions of the Virtual Sensor's data) is dependent on the choice of covariance K, representing the assumptions about the underlying function. The covariance function relates one observation to another. As observations made at points close to x are likely to be well correlated it can be assumed that the output for any target value x* will be correlated to nearby observations. Although a simple, single term covariance function will suffice for some data sets, it is often the case that the data will have numerous, complex features that need to be modeled. For instance, a data set may be modeled to be the sum of two independent functions f1(x) and f2(x). In this case, the covariance function can be extended accordingly by adding terms for each function. A parallel can be drawn here to other time series forecasting techniques such as Holt Winters' exponential smoothing where extra parameters are introduced to encode multiple trends in the data.

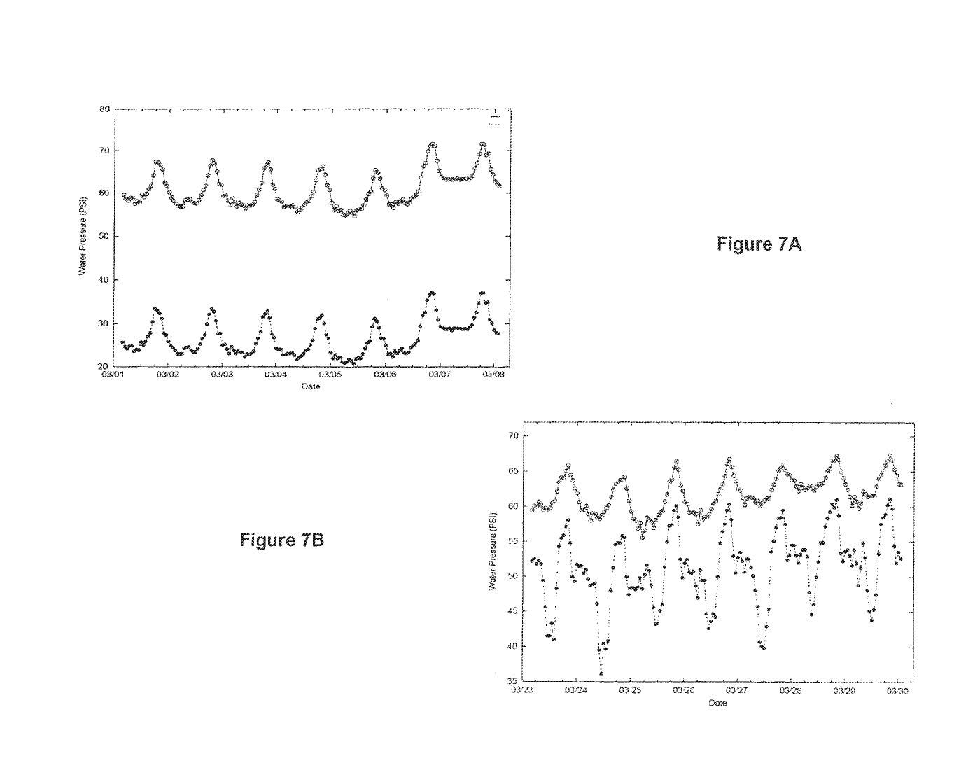

FIGS. 7A and 7B show examples of hourly averaged pressure data collected by sensors over the course of one week. Aside from the observation that the streams in FIG. 7A are strikingly similar in trend (but offset in magnitude from one another), and that the streams in FIG. 7B are different, several temporal trends are apparent in the data. Firstly, each data stream has a strong diurnal pattern, which is known to be related to the consumer demand. Secondly, there are long term trends that change over several days or more, such as higher pressure values at the weekend than during weekdays, or longer term (over weeks or months, not shown here). Finally, there are short-term trends and fluctuations that happen over a period of hours, particularly during the daytime, when consumption is at its most variable in the water distribution system.

It is important that terms of the covariance function can assert these assumptions about the patterns in the pressure data gathered by the Virtual Sensors to provide accurate predictions. Based on the patterns in the individual data streams, the covariance function is constructed to be the sum of a periodic function k1 to represent the daily pattern, and a non-periodic component k2 that maps the trend over time. This fits the expectation that sensed pressure readings can be modeled by the combination of a periodic signal, and a second term to take account of longer-term trends. Both covariance terms are represented by the Matérn function, which provides flexibility over other popular covariance functions, such as the squared exponential. The generalized Matérn covariance function is

$${k}_{matern} = {h}^{2} \frac{{2}^{1 - v}}{Γ ( v )} {( \frac{\sqrt{2 vd}}{w} )}^{v} {K}_{v} ( \frac{\sqrt{2 vd}}{w} ) \qquad ( 7 )$$

where d=|x−x′| is the absolute distance between input samples, v is a smoothness parameter (with higher values of v giving smoother functions), Kv is the modified Bessel function and is the Gamma function. h is a height parameter and w a width parameter; these are commonly known as Hyperparameters of the Gaussian Process and are discussed in more detail later in this section.

Through experimentation, the smoothness parameter v=5/2 has proved to be a good match to pressure patterns seen in the water distribution system. The chosen covariance function with v=5/2 is written as

$${k}_{v = 5 / 2} = {h}^{2} ( 1 + \frac{\sqrt{5 d}}{w} + \frac{5 {d}^{2}}{3 {w}^{2}} ) exp ( - \frac{\sqrt{5 d}}{w} ) \qquad ( 8 )$$

The mapping between points in time can be modified to model periodic functions (such as diurnal patterns) by replacing the input space function d=|x−x′| with d=sin|x−x′|. The width and height Hyperparameters w and h can be used to alter the behavior of the function. w affects the relationship of the distance between samples, tuning to what degree samples further from x should influence the covariance. Larger values for w produce smoother functions, but likely at the expense of short-term detail (and hence model fit). As regular, hourly sampling intervals are expected for the pressure data, the scale is set to the unit length, i.e. w=1. The output height h is effectively a scaling factor on the output of the covariance function, limiting the variance of the covariance function output; h is typically set to be the standard deviation of the observed data.

Values for these Hyperparameters have been determined to perform well based on prior experimentation with pressure data sets. However, if future experimentation shows poor results, it is possible to exploit the confidence values generated by the Gaussian Process to further optimize the Hyperparameters by optimizing the marginal likelihood.

In monitoring situations it is not possible to know the ground truth measurements, as the sensors can only observe a noise corrupted version. To account for the estimated measurement noise, the covariance function can be extended as follows

K(x,x′)=k₁(x,x′)+k₂(x,x′)+σₙδ(x,x′) (9)

where n represents the estimated measurement noise and is the Kronecker delta

$${δ}_{ij} = \{ \begin{matrix}0 & if i \neq j \\ 1 & if i = j\end{matrix} \qquad ( 10 )$$

The amount of estimated measurement noise becomes another Hyperparameter of the Gaussian Process and is set to 0.2 based on prior experimentation.

As discussed earlier in this section, data prediction for Virtual Sensors requires that the candidate virtual sensor be well matched (correlated) with a real sensor in the network. FIGS. 7A and 7B show examples of when sensor data is well matched and poorly matched respectively. In order to influence data prediction, the correlation between sensors must be captured in the covariance function. To capture the correlation, a multiplicative term over the sensor identifier 1 is applied to the covariance. This term is defined as the Pearson r correlation coefficient between the two sensors under consideration.

For time alone as the relationship between inputs and outputs decreases, the output of the covariance function approaches zero, and accordingly has less impact in the regression process. A similar approach can be taken to represent the correlation between separate nodes, by weighting the output of the covariance function by a correlation coefficient representing the relationship between sensors. For highly correlated sensors (r≈1) the output of the covariance remains relatively unchanged. The relationship between uncorrelated sensors (r≈0) is reduced. During the calculation of the covariance matrices K and more specifically K, the weighting the Gaussian Process gives to uncorrelated sensors when producing the conditional probability of test values is reduced accordingly.

The extended covariance function K over x and l then becomes

K([x,l],[x′,l′])=k_{node}(l,l′)(k₁(x,x′)+k₂(x,x′))+σₙδ(x,x′) (11)

This allows the covariance function to capture temporal and spatial changes, providing the necessary capability to support a Virtual Sensor.

Using GPR for data prediction has a computational complexity O(N3). Therefore, as the input (training) data increases in size linearly, the computation time will increase by a power of three. Because the Virtual Sensors system is intended to provide timely input to the on-line hydraulic model, care must be taken to restrict the input data to provide realistic computation times.

Whilst iterative schemes for GPR have been shown to be efficient, the Virtual Sensors approach relies on learning the relationship between sensors over a short period of time, and then continuing to use this learned data to inform future predictions. However, it is computationally infeasible to use all previously gathered data to train against. To address this, a windowing scheme is applied, considering a sliding window of two weeks worth of input data. The first week is treated as training data, and the second is used to learn the current (i.e. most recent) trends of data. A related problem is using training data that is not evenly spaced (in terms of sampling interval) and that may even have gaps on the order of several hours to days. In this case, the accuracy of predictions will be impaired due to lack of data. To resolve this, any missing values in the training set are replaced by the output of the prediction for that point in time. This ensures a full training set is retained as well as considering the most up to date sensor data.

For validation two test cases are considered: a short-term, controlled experiment where to validate the GPR's predictions, and a long-term, in-situ Virtual Sensors experiment performed over six weeks, complete with cross-validation.

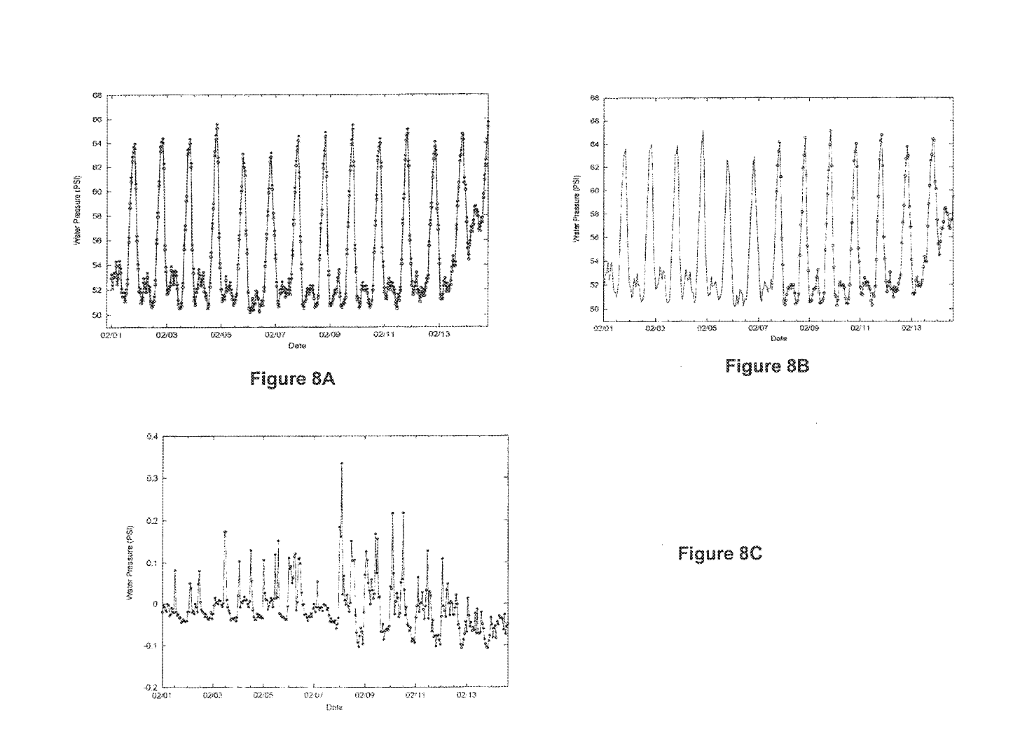

Two hourly averaged pressure data traces were taken from two sensors (herein referred to as A and B) permanently deployed 600 meters apart on the same 800 mm pipe main. The data traces are shown in FIG. 8A. These particular sensors and time period were chosen for two reasons: firstly, the sensor data are very well-matched (r=0.999) and secondly because the data show a significant upward change in trend toward the end of the trace. This trend is not something that could be predicted purely using the time history of the data, and thus indicates the performance of the correlation term in the GPR's covariance function that is fundamental to the Virtual Sensors approach.

In the test, Sensor A was correlated with sensor B, and the prediction ran alongside the observations. After seven days (168 data points), the data stream from sensor A was removed, leaving the GPR to predict the remaining 168 data points. FIG. 8B shows the predicted points overlaid on the observed data stream, starting from when sensor A's observed data stream was removed. It is clear that the GPR takes into account the reference data stream from sensor B, and thus adapts to the upward trend change in the data set. FIG. 8C shows the model error (observed minus estimated) for all prediction points, including those before sensor A's data stream was removed. The Root Mean Squared Error of the predictions was 0.074 PSI, and the maximum error 0.33 PSI. This prediction accuracy is adequate for input to the on-line modeling of hydraulic state, which can tolerate uncertainty in pressure data inputs of around ±1.5 PSI.

These results validate the GPR as a suitable prediction technique for the Virtual Sensors approach, as well the choice of covariance function terms.

In order to validate the complete Virtual Sensors approach over a longer time period, a cross-validation experiment was performed. A mobile sensor node was temporarily deployed to gather pressure data. This data was averaged hourly and observed to be well correlated both visually and statistically with an existing real sensor (r=0.999). The two data streams, averaged hourly are shown in FIG. 7A. A Virtual Sensor was added to the system for this site, providing predictions based on the historical data and the data being gathered by the correlated sensor node.

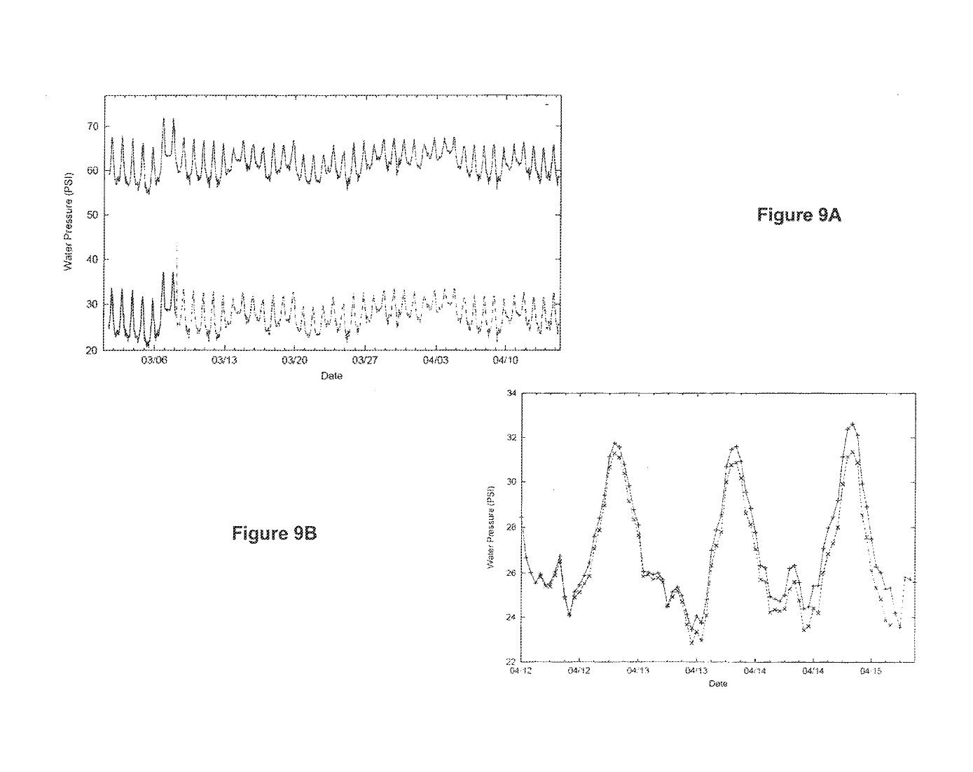

FIG. 9A shows an overview of the GPR's predictions of the Virtual Sensor's data trace using the training data and the data from the well-matched real sensor. Both the real sensor's data stream and the Virtual Sensor's training data are shown in solid lines, and the GPR predictions are shown as a dashed line. The initial leap in prediction after the training data stopped is a side effect of the correlation covariance term settling, and only lasts for the first predicted data point. This effect is not as pronounced when the data streams are almost exactly the same, which explains why this phenomenon was not observed in the controlled experiment.

FIG. 9B shows the observed and predicted pressure data traces during the cross-validation period. The RMSE between the predicted data and the observed values was 0.756 PSI, with a maximum error of 1.394 PSI. These values are still within the acceptable boundaries of measurement uncertainty allowed by the on-line model. This result shows that the predicted data are very well matched with the observed pressure data after an extended time period (thirty-six days).

1. A method of modelling a water distribution system, the method comprising steps of:
identifying a plurality of demand zones within said water distribution network;
estimating water consumption data for said demand zones;
simulating the hydraulic characteristics of the water distribution system using said estimated water consumption data and so;
providing simulated pressure and flow rates within said demand zones;
receiving output from sensors within said water distribution network in the form of pressure and flow rate data;
correcting the simulated pressure and flow rate data within said demand zones based upon the sensor output and so;
calibrating a model of the water distribution system.

2. The method according to claim 1, further including the step of predicting water consumption data using the calibrated water distribution model.

3. The method according to claim 2, further including the steps of simulating the hydraulic characteristics of the water distribution system using said predicted water consumption data and so providing predicted pressure and flow rate data within said demand zones.

4. The method according to claim 3, further including the steps of subsequently measuring pressure and flow rate data from said sensors for a time period corresponding to said predicted pressure and flow rate data, and comparing with predicted pressure and flow rate data.

5. The method according to claim 4, further including the step of re-calibrating the water distribution model based on the comparison of sensor output and predicted data.

6. The method according to claim 1, wherein the step of receiving output from sensors is a continual process having a time step between each receiving step, with the correcting and calibrating steps repeated from each time step.

7. The method according to claim 1, wherein the sensor output includes data from virtual sensors, said data from said virtual sensor determined by a method comprising steps of:
providing historical output from a temporary sensor;
comparing historical output with output from at least one permanent sensor; determining a correlation between said temporary sensor and permanent sensor output then;
receiving subsequent output from said at least one permanent sensor and; determining data from said virtual sensor corresponding to the temporary sensor using subsequent output and correlation.

8. The method according to claim 1, further including receiving transmission data including reservoir elevations and pump flow, said transmission data used with said sensor output for correcting the simulation pressure and flow rate data within said demand zones.

9. The method according to claim 2, using the corrected simulation data for a cycle corresponding to a time period corresponding to said predicted data.

10. A method of determining the output from a virtual sensor, the method comprising steps of:
providing output from a first sensor at a first node;
comparing the output from the first sensor with output from at least one permanent sensor;
determining a correlation between output of the first sensor and the at least one permanent sensor, then;
receiving s subsequent output from said at least one permanent sensor and consequently; and
determining the virtual sensor output at the first node corresponding to the subsequent output and the correlation.

11. The method according to claim 10, wherein the step of determining said virtual sensor output at the first node uses a data imputation technique to combine the correlation and the subsequent output.

12. The method according to claim 11, wherein the data imputation technique is Gaussian Process Regression.

13. The method according to claim 2, wherein the sensor output includes data from virtual sensors, said data from said virtual sensor determined by a method comprising steps of:
providing historical output from a temporary sensor;
comparing historical output with output from at least one permanent sensor; determining a correlation between said temporary sensor and permanent sensor output then;
receiving subsequent output from said at least one permanent sensor and; determining data from said virtual sensor corresponding to the temporary sensor using subsequent output and correlation.

14. The method according to claim 2, further including receiving transmission data including reservoir elevations and pump flow, said transmission data used with said sensor output for correcting the simulation pressure and flow rate data within said demand zones.

15. The method according to claim 3, wherein the sensor output includes data from virtual sensors, said data from said virtual sensor determined by a method comprising steps of:
providing historical output from a temporary sensor;
comparing historical output with output from at least one permanent sensor; determining a correlation between said temporary sensor and permanent sensor output then;
receiving subsequent output from said at least one permanent sensor and; determining data from said virtual sensor corresponding to the temporary sensor using subsequent output and correlation.

16. The method according to claim 3, further including receiving transmission data including reservoir elevations and pump flow, said transmission data used with said sensor output for correcting the simulation pressure and flow rate data within said demand zones.

17. The method according to claim 3, using the corrected simulation data for a cycle corresponding to a time period corresponding to said predicted data.

18. The method according to claim 4, wherein the sensor output includes data from virtual sensors, said data from said virtual sensor determined by a method comprising steps of:
providing historical output from a temporary sensor;
comparing historical output with output from at least one permanent sensor; determining a correlation between said temporary sensor and permanent sensor output then;
receiving subsequent output from said at least one permanent sensor and; determining data from said virtual sensor corresponding to the temporary sensor using subsequent output and correlation.

19. The method according to claim 4, further including receiving transmission data including reservoir elevations and pump flow, said transmission data used with said sensor output for correcting the simulation pressure and flow rate data within said demand zones.

20. The method according to claim 4, using the corrected simulation data for a cycle corresponding to a time period corresponding to said predicted data.
